(19) United States
(12) Patent Application Publication
(10) Pub. No.: US 2007/0095850 A1
(43) Pub. Date: May 3, 2007

(54) Multiple medication dispensing system

(76) Inventor: Daniel D. Meyer, Hanover, NH (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/260,862

(22) Filed: Oct. 27, 2005

(51) Int. Cl. G07F 11/00

(52) U.S. Cl. 221/2

(57) ABSTRACT

Disclosed is a multi-compartment drug dispensing device, for dispensing multiple medications to a patient. The device includes a plurality of compartments, for holding a plurality of drugs. Each compartment is separately labeled with information relevant for the contents of that compartment. The compartments may be associated into groups, corresponding to the desired administration protocol. Groups of compartments may be arranged on a strip, and multiple strips may be provided in a container such as a dispensing box, to provide a system for dispensing multiple drugs per day, over a course of multiple days. Methods are also disclosed.

### BACKGROUND OF THE INVENTION

1. Field of the Invention

The present invention relates to systems that contain and dispense a plurality of individually labeled associated medicines.

2. Description of the Related Art

The past three decades has witnessed an explosion in the development of new medications which have been tested in a wide variety of clinical settings. These medications have been studied alone and in combination for specific indications. As a result, patients with various medical problems are often prescribed multiple different medications. Some non-limiting examples of diseases that generally have a greater chronicity and often require multiple medications include coronary artery disease, congestive heart failure, diabetes mellitus, renal failure, liver failure, human immunodeficiency virus (HIV), acquired immune deficiency syndrome (AIDS), breast cancer, Parkinson's disease, and tuberculosis. There are also regimens for the prevention of disease, or primary prevention programs, such as for hypertension, hypercholesterolemia and bone demineralization. Furthermore, some patients with medical problems that are generally more acute may be required to take multiple medications for extended time periods as well, such as 5 days, 7 days, 10 days, 14 days, a month, 2 months, 3 months, 6 months, or more, for example, diverticulitis, acute deep venous thrombosis, acute thyroiditis, or endocarditis, and the like. Success of these medical regimens is highly dependent upon the ability of the patient to take each of these medications at a specific time.

These advances in medical science, particularly in pharmacotherapy, have not been accompanied by advances in how medications are dispensed. Currently, each medication prescribed is dispensed separately with in its own individual package system, which is typically a vial, which may be a cylindrical container with a tamper and child resistant cap. For example, a patient who is on six medications may receive six separate prescriptions from the patient's physician. The patient then brings these to a pharmacy. The pharmacy then fills each prescription individually, providing the patient/customer with six separate vials. The patient then must open each vial every time he/she wishes to take the specific medication.

Current vial systems have a number of limitations. The vial size is dictated by the prescription, which specifies the number of pills to be dispensed. For example, containers for a 90-day prescription for two pills to be taken each morning must be large enough to contain 180 pills. These vials may be the size of the common soda can, too large for the patient to carry around in a small purse or briefcase. Because each medication is prescribed individually, a patient will often receive medications (directly from the pharmacy or by mail) at different times and intervals. This commonly results in patients having multiple vials of the same medications. Successfully tracking and managing of each medication is time consuming, and often confusing and frustrating. Confusion regarding multiple medications and possible redundant prescriptions may lead to a patient taking less, or more of the drug than prescribed, potentially causing undertreatment, or worse yet, a life-threatening overdose.

For example, based upon guidelines from the American College of Cardiology, patients diagnosed with a myocardial infarction, and patients diagnosed with unstable angina typically receive, if indicated, at least 5 medications after leaving the hospital. Congestive heart failure and organ transplant patients are also each prescribed a combination of a number of drugs.

Similarly, patients are prescribed multiple medicines for the treatment of HIV, AIDS, diabetes mellitus, tuberculosis, rheumatoid arthritis, systemic lupus erythematosis, strokes, and other common chronic diseases. As noted above, some patients with acute medical problems may also be required to take multiple medications for an extended time period. Available data indicate that a majority of these patients adhere to their therapeutic regimens in the six months after discharge, but that compliance often deteriorates with time.

To make matters even worse, in addition to the patient having multiple conditions, each of which may require multiple medications, these medications are often prescribed by different providers/physicians.

Therefore, it would be beneficial if there were a unified system which consolidated the multiple prescriptions, and allowed for the supply of medications in an easy-to-use daily format. The patient would benefit from having the means of supply that was small enough to carry in a small purse or shirt pocket, be easy to open, be easy to identify for each pill, and streamline/replace the tedious task of filling individual prescriptions. Furthermore, the simplified system would encourage patient compliance and potentially improve overall health. Furthermore, such a system could decrease the risk of adverse events from a patient taking an incorrect dosage.

### SUMMARY OF THE INVENTION

The present invention relates to systems that contain and dispense a plurality of individually labeled associated medicines. The system includes a number of compartments for holding individual doses of medicines or types of medicines. The present invention also includes combining multiple medications into the system. In a preferred embodiment, the multicompartment housing may be in the configuration of a strip.

One embodiment of the system is a dispenser that, when activated, dispenses one or more medicines. Another embodiment is a strip that contains one day's worth of prescriptions. In a preferred embodiment, multiple strips may be detachably connected to one another. Each strip may be opened separately from the other strips, and each compartment on a given strip may be opened simultaneously with or separately from the other compartments on that strip. The present invention contains all the required labeling for an individual prescription (i.e., provides information regarding the medications, the prescribing physician, filling pharmacist and the patient) sufficient for each compartment to constitute a separate vial. The invention also includes devices for filling the system, which may be a stand-alone device or an adapter that allows traditional fulfillment machines to fill the system.

In accordance with one implementation of the present invention, there is provided a multi-compartment drug dispensing device. The device comprises at least a first compartment and a second compartment. At least a first pill is provided in the first compartment and at least a second pill is provided in the second compartment. A first label is provided on the first compartment, containing information relating to the first pill, and a second label is provided on the second compartment, containing information about the second pill.

The information on the first label includes, for each specific pill, the drug name and serial number, the patient name and the prescriber's name. Additional information concerning that pill, the patient or the use of the pill may also be included. The multi-compartment drug dispensing device may include at least three compartments, at least five compartments, at least seven compartments, or more, depending upon the intended functionality. The compartments may be detachably connected to each other. Each compartment may be opened separately from the other compartments.

At least one compartment contains a pill that comprises a prescription medication. At least one compartment may contain a pill that comprises a nonprescription medication. Any of the compartments may include one or more of a statin, aspirin, an ACE inhibitor, an anti-thrombotic agent, an anti-platelet agent, a thienopyridine, an ARB, a cholesterol agent, or an oral hypoglycemic agent.

In one implementation of the invention, intended for dispensing to a patient diagnosed with myocardial infarction or unstable angina, the multi-compartment drug dispensing device includes at least 5 compartments. A first compartment includes a dose of aspirin, a second compartment includes a dose of a thienopyridine, a third compartment contains a dose of a beta blocker, a fourth compartment includes a dose of an ACE inhibitor, and a fifth compartment includes a dose of a statin. Each compartment additionally includes a label with information relating to the contents of that compartment.

In accordance with another implementation of the invention, intended for prescription to a congestive heart failure patient, a multi-compartment drug dispensing devices includes at least a first compartment containing a dose of aspirin, a second compartment containing a dose of a beta blocker, a third compartment containing a dose of a diuretic, and a fourth compartment containing a dose of a positive inotropic agent (such as digoxin). Each compartment additionally includes a label with information relating to the contents of that compartment.

In accordance with another aspect of the present invention, a plurality of the multi-compartment drug dispensing devices described above are associated together as a single article, such as by containment within a single outer packaging. At least the first compartment in any multi-compartment drug dispensing device may include a peel-away cover, such as a metal foil or polymeric membrane. The compartment may alternatively include a perforation line, slot, indent, or crease, to facilitate tearing. The compartment may alternatively include a frangible barrier, such as a thin metal foil, which may be torn or punctured to release the dose of medication.

In accordance with a further aspect of the present invention, there is provided a multi-compartment container. The container comprises a housing, defining a plurality of wells. A removable cover is provided, for covering the plurality of wells to define a plurality of enclosed compartments. A dose of medication is contained in each compartment. A label is provided on each compartment, which includes information such as at least an identification of the medication contained in that compartment, the dose of the medication, a patient's name, the prescribing physician's name, the pharmacy/pharmacist's name and a prescription number.

The removable cover may comprise a peel-away membrane. Alternatively, the removable cover may be snap fit or slidably carried by the housing.

In accordance with a further aspect of the present invention, there is provided a multiple drug dispensing system. The system comprises a first housing, having a plurality of multi-compartment containers therein. Each multi-compartment container comprises a second housing, defining a plurality of wells. A removable cover is provided, for covering the plurality of wells to define a plurality of enclosed compartments. A dose of medication is contained in each compartment. A label is provided on each compartment, which includes an identification of information associated with the dose of medication contained within the compartment. The information may include at least the identification of the medication contained in that compartment, the dose of the medication, a patient's name, the prescribing physician's name, the pharmacy/pharmacist's name, and a prescription number.

The first housing may be provided with an opening, to allow removal of the multi-compartment containers.

In accordance with a further aspect of the present invention, there is provided a method of packaging a multiple drug therapy. The method comprises the steps of providing a multi-compartment container, and placing a first dose of a first drug in a first compartment. A second dose of a second, different drug, is placed in a second compartment. The first compartment is labeled with information relating to the first drug, and the second compartment is labeled with information relating to the second drug.

The method may additionally comprise the step of applying a removable cover to enclose each compartment. The method may additionally comprise the step of associating a plurality of multi-compartment containers into a single unit. The associating step may comprise wrapping the multi-compartment containers together in an outer wrapping. Alternatively, the associating step may comprise placing the multi-compartment containers in an outer container. Alternatively, the associating step may comprise releasably securing the multi-compartment containers to each other. The releasably securing step may comprise providing perforations or a tear-line between adjacent multi-compartment containers, or providing a layer of a pressure sensitive adhesive or other adhesive between adjacent multi-compartment containers.

In accordance with another aspect of the present invention, there is provided a method of treating a patient. The method comprises the steps of providing a plurality of multi-compartment housings, each housing containing a dose of each of at least three different drugs to be taken by the patient. Each dose is contained within a unique compartment within the housing, and the housing is provided with a unique label for each dose. An instruction is provided to the patient, to select one of the plurality of housings at a predetermined time interval, and opening the housing to release the dose of each of the three different drugs.

In accordance with another aspect of the present invention, there is provided a method of treating a patient post-myocardial infarction. The method comprises the steps of providing a plurality of multicompartment housings, each housing containing a dose of at least three different drugs to be taken by the patient; where said drugs are a statin, a beta-blocker, and an ACE inhibitor, each dose contained within a unique compartment within the housing and the housing having a unique label for each dose. Also, an instruction is provided to the patient to select one of the plurality of housings at a predetermined time interval, and open the housing to release the dose of each of the said at least three different drugs. In another embodiment, each housing additionally comprises a dose of an aspirin. In another embodiment, each housing additionally comprises a dose of a thienopyridine. In yet another embodiment, each housing additionally comprises a dose of an aspirin and a thienopyridine.

In accordance with another aspect of the present invention, there is provided a method of treating a patient with congestive heart failure. The method comprises the steps of providing a plurality of multicompartment housings, each housing containing a dose of at least three different drugs to be taken by the patient; where said drugs are a diuretic, a beta-blocker, and an ACE inhibitor, each dose contained within a unique compartment within the housing and the housing having a unique label for each dose. Also, an instruction is provided to the patient to select one of the plurality of housings at a predetermined time interval, and open the housing to release the dose of each of the said at least three different drugs. In another embodiment, each housing additionally comprises a dose of a positive inotropic agent. In another embodiment, each housing additionally comprises a dose of a statin. In yet another embodiment, each housing additionally comprises a dose of an aspirin. In another embodiment, each housing additionally comprises a dose of an aspirin and a statin. In another embodiment, each housing additionally comprises a dose of an aspirin and a positive inotropic agent. In another embodiment, each housing additionally comprises a dose of a statin and a positive inotropic agent. In another embodiment, each housing additionally comprises a dose of a statin, an aspirin, and a positive inotropic agent.

In accordance with another aspect of the present invention, there is provided a method of treating a patient with diabetes mellitus. The method comprises the steps of providing a plurality of multicompartment housings, each housing containing a dose of at least three different drugs to be taken by the patient; where said drugs are sulfonylurea, a biguanide, and an ACE inhibitor, each dose contained within a unique compartment within the housing and the housing having a unique label for each dose. Also, an instruction is provided to the patient to select one of the plurality of housings at a predetermined time interval, and open the housing to release the dose of each of the said at least three different drugs. In another embodiment, said drugs in each housing are a sulfonylurea, a thiazolidinedione, and a biguanide. In another embodiment, said drugs are a sulfonylurea, a thiazolidinedione, and an ACE inhibitor. In yet another embodiment, said drugs are a thiazolidinedione, a biguanide, and an ACE inhibitor.

Further features and advantages of the present invention will become apparent to those of ordinary skill in the art in view of the detailed description of preferred embodiments which follows, when considered together with the attached drawings and claims.

### BRIEF DESCRIPTION OF THE DRAWINGS

FIG. 1 is a single strip containing a single days-worth of five medicines.

FIG. 2 is a cross sectional view taken along the line 2-2 in FIG. 1.

FIG. 3 is a perspective, schematic view of another embodiment of a multiple medication dispensing system in accordance with the present invention.

FIG. 4 is a rear view of the strip shown in FIG. 1.

FIG. 5 is a view of one side of the strip where each compartment is separately labeled.

FIG. 6 is a view (at left) of labeling for individual compartments, which is folded on one side of the compartments, and a side view (at right) of a compartment where the labeling is shown folded on the right side of the compartment.

FIG. 7 is an apparatus that dispenses medicines.

FIG. 8 is a rear view of the apparatus shown in FIG. 7.

FIG. 9 is the apparatus shown in FIG. 7 with the top opened, showing a plurality of multi-compartment drug dispensing strips inside.

### DETAILED DESCRIPTION OF THE PREFERRED EMBODIMENT

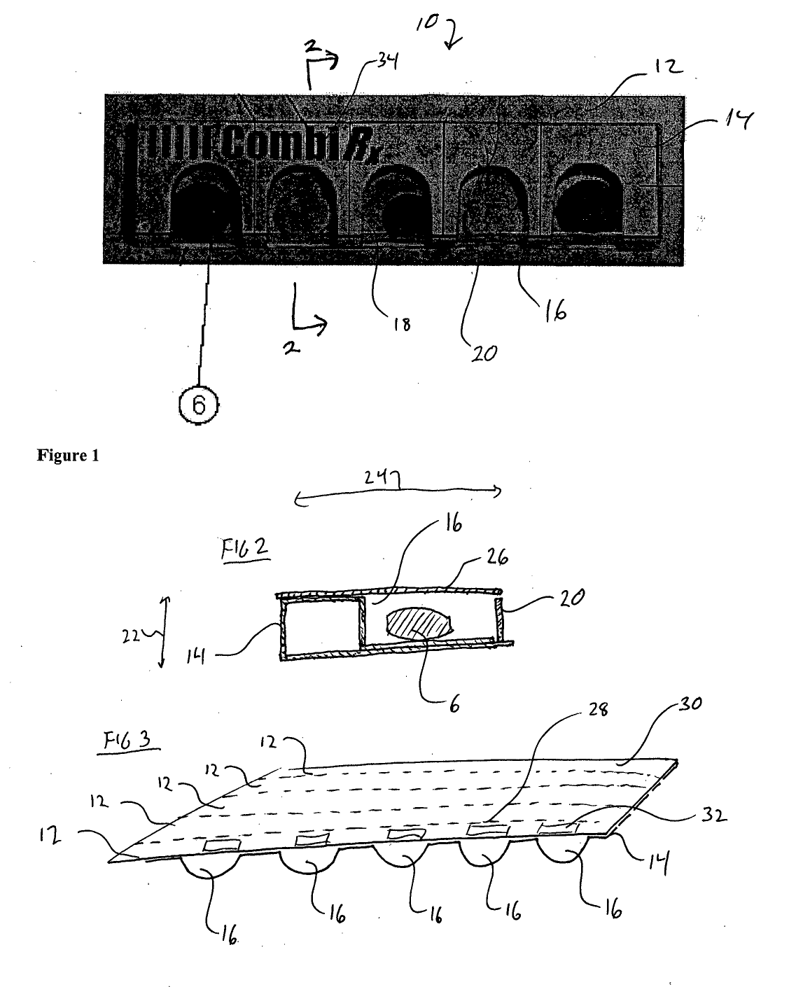

One embodiment of the multi-compartment drug dispensing device 10 of the present invention is a strip 12 shown in FIG. 1. In this embodiment, the strip contains a single dose of each of five medicines 6. The strip could contain at least two, or at least five or at least seven or any number of medicines. The strip 12 comprises a support or housing 14 which is provided with a plurality of wells 16 for holding the medication. The housing 14 may be manufactured in any of a variety of ways which will be understood by those of skill in the art such as by molding, machining, stamping or vacuum forming a sheet of plastic at an elevated temperature. The compartments 16 holding each dose are separated from one another by a plurality of dividers 18. The dividers 18 may be integrally formed with the housing 14, or may be separately fabricated and attached to a support to form the plurality of wells 16. The dividers 18 may additionally be configured to create an air tight or fluid tight seal for each compartment 16, or may be configured to prevent medications 6 from mixing but otherwise permit the passage of air between compartments 16.

In the illustrated embodiment, each dose is a single pill or capsule 6, although the invention may contain more than one pill or capsule in each compartment, or even different types of medicine in the same compartment 1. Thus, it may be convenient for each compartment 16 to contain a single dose of a single medication, however that a single dose may be contained in one, or two, or three, or four, or more pills as is understood in the art. Therefore, a particular pill referred to herein may refer to one, or two, or three, or four, or more pills of the same medication. In addition to the more common oral or sublingual formulations, the compartment may contain other forms of medicines, such as transdermal, rectal, intramuscular, subcutaneous, intradermal, or inhaled formulations.

The illustrated embodiment also has a plurality of windows 20, which may each measure within the range of from about 0.25 cm to approximately 1.5 cm in width for each compartment, which provides a means to inspect the contents of each compartment 16. Material for the window 20 as well as the other walls of the compartment 16 preferably has properties to block ultraviolet light. Furthermore, each compartment may be water resistant, tamper resistant, and child resistant.

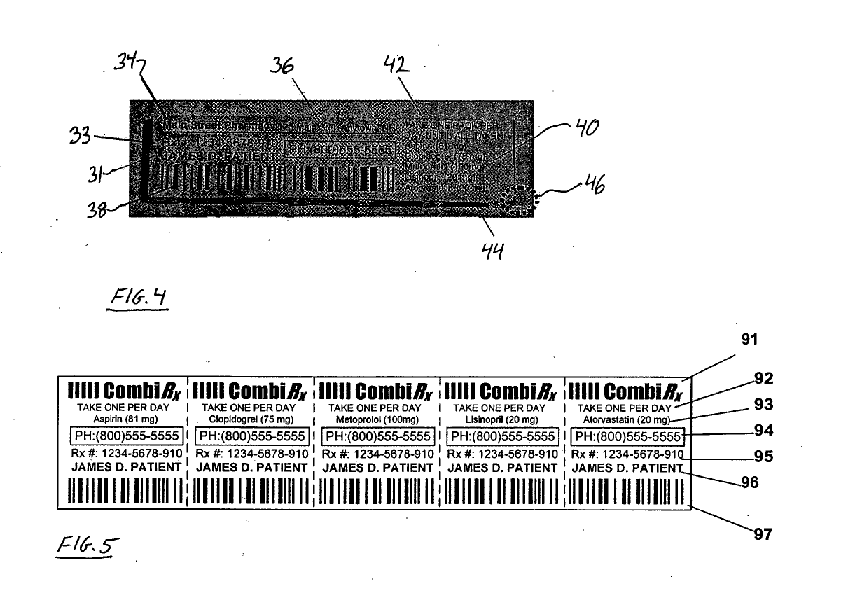

Referring to the cross sectional view illustrated in FIG. 2, the strip 12 may have a rectangular cross sectional configuration having a short dimension along a first axis 22 and a long dimension along a second axis 24. This configuration allows a plurality of the multi-compartment drug dispensing device 10 to be conveniently stacked and packaged in a single unit, as will be discussed below. As discussed below, the individual strips 12 are arranged such that the short dimension 22 may be exposed to the patient, while the plurality of strips 12 are maintained within their container. For this reason, the window 20 may conveniently be placed along the narrow edge 22 of the strip 12.

The wells 16 may be conveniently enclosed to form a sealed container by placing a wall 26 along the length of the strip 12. Wall 26 may be secured in any of a variety of ways known in the art, such as by the use of adhesives, heat bonding, or other known technique. The wall 26 may be made from an optically transparent plastic, to permit visualization of the contents of each compartment from the top, as seen in FIG. 1, once the multi-compartment strip has been removed from a multiple strip container.

The strip 12 in this embodiment also has a means to open the strip such as a pull tab 12. The means of opening allows the person for whom the medicines are intended or his/her caregiver to open the strip and dispense the medicines. The pull tab 12 may be a portion of or connected to a peel-away membrane, such as a thin sheet of metal or polymeric material. Alternatively, the pull-tab 12 may be associated with a single strand or multi-strand pull wire, for severing a side wall on the device to allow access to its contents. The strip may alternatively include a frangible membrane for covering each of the compartments, which may be punctured or ruptured by manual compression on the opposing side of the pill, to allow access to the medication. Frangible membranes may comprise a thin metal film, or polymeric film. The strip may alternatively be opened by tearing along a perforation line, or along a crease or score line. Alternatively, the strip may comprise an inner tray, which is slidably removed within an outer sleeve. The outer sleeve may comprise a transparent plastic, to permit visualization of the contents as has been discussed. The outer sleeve covers each of a plurality of indents or wells in the inner tray, to form a plurality of enclosed compartments. The outer sleeve may be slidably removed from the tray, allowing access to each of the compartments. In other embodiments, the means of opening the strip may utilize an additional opener structure or tool, manual removal of the wall, or other means of opening the strip.

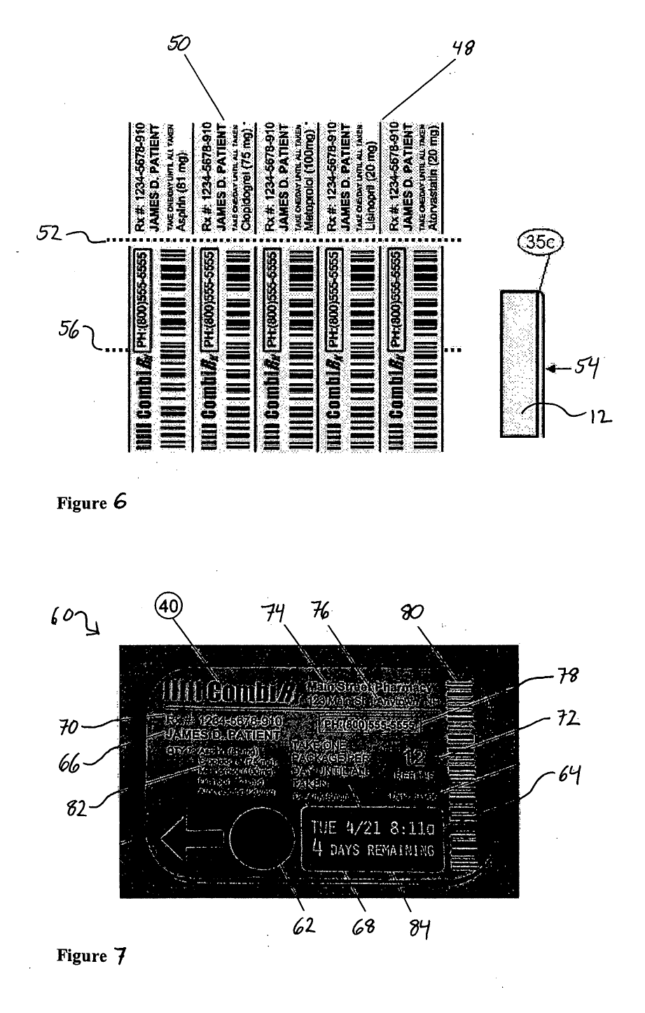

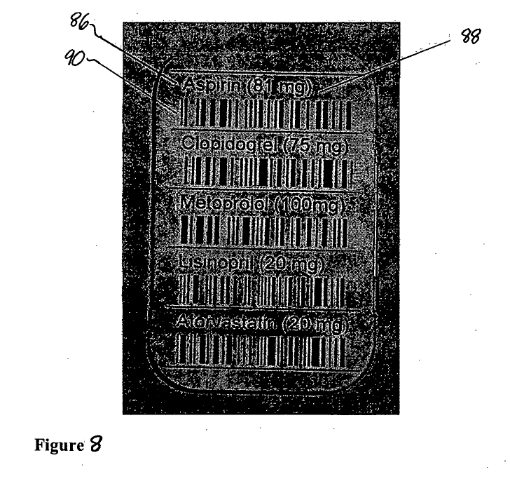

The multi-compartment strip 12 in accordance with the present invention may be constructed in any of a variety of ways, as will be apparent to those of skill in the art in view of the disclosure herein. For example, an alternative construction is schematically illustrated in FIG. 3. In this embodiment, a plurality of wells 16 are formed in a plastic sheet, preferably comprising an optically transparent, UV inhibiting plastic. In the illustrated embodiment, the wells 16 are arranged in five rows of five. A perforation line 28 or other crease or indent to facilitate separation is provided in between each successive row of wells 16, to provide in the illustrated embodiment five detachably connected strips 12. Once the medications (not illustrated) have been loaded into the appropriate wells 16, a backing layer 30 may be applied using adhesive, thermal or other bonding technique to enclose each well into a unique compartment. The backing layer 30 may have a plurality of labels 32 printed thereon, or fixed thereto, for containing information relating to the medication in each corresponding compartment 16.

In use, the patient or a caregiver may tear a single strip 12 along perforation line 28 to separate it from the remainder of the assembly, and grasp a pull tab or free end of the backing layer 30 and peel the backing layer 30 away to open each of the compartments 16 in that strip 12.

The strip in any of the foregoing embodiments may also include a logo 34. In the embodiment of FIG. 1, the logo is placed on the upper left-hand corner of the front of the strip. In embodiments that include a logo, the logo may be placed on the front or back of the strip.

The strip 12 may also include indicia of other information relating to the medication and its use, as shown on the back of the embodiment of FIG. 1 and illustrated in FIG. 4. This information may be directly on the back of the embodiment, or on a label adhered to the back of the embodiment, and includes the name 31, phone number, account number and address of the person for whom the medicines are intended; a prescribing physician's name, phone number and address; a prescription number (if the medicines are provided under a prescription) 33; number of refills remaining on a prescription (if the medicines are provided under a prescription) and date of the prescription; the name and address 34, and phone number 36 of a pharmacy or other retail establishment; a bar code 38; the name and/or dose of the medicines 40; instructions regarding taking the medicines or restrictions regarding taking the medicines 42. One skilled in the art will recognize that the information listed may be varied, or additional information added, dependent upon the desires of the patient, pharmacy, or health care provider, or to comply with federal, state, or local regulations regarding vial labeling or pharmacy practice.

FIG. 4 also shows the openings 44 on the bottom of the strip that allows for dispensing of the medicines, (not illustrated) as well as the pull tab or other means to open the strip 46.

The strip 12 may also include individual labeling for each medicine, such as in the example shown in FIG. 5. In this case, the individual labeling will be attached to the compartment to which is corresponds, and when the compartments are separated, the individual labels will separate from each other in a similar manner.

FIG. 6 is a view (at left) of a sheet of labeling for individual compartments for an embodiment of the type illustrated in FIG. 1, which is folded on one side of the compartments, and an end view (at right) of a strip 12 where the labeling is shown folded on the right side of the compartment. Perforations 48 allow the labels to be separated when the corresponding compartments are separated. Individual medicine names or other identifiers 50 correspond to the compartment to which the individual label is attached. Above the line 52 is the information that is shown on the outside, corresponding to 54. The fold line 56 corresponds to 58.

Another embodiment of the invention is a dispenser 60, as shown in FIG. 7. In this embodiment, the dispenser 60 contains seven days worth of five types of medicines per day. The dispenser 60 may alternatively contain a two-week, or one month supply, or other period of supply. The invention may contain one or more dose of one or more medicines.

This embodiment involves a button 62 that is pushed to dispense a dose of medicines. The button 62 may or may not be electronic or mechanical. The invention may or may not utilize one or more of a button, lever, slider switch or other component to dispense the medicines.

This embodiment may also include an electronic display 64. In this embodiment, the display shows the day, date, time and number of day's worth of medicines remaining. The invention may or may not include such information. The invention may also display information in other means, including the use of light-emitting diodes, or liquid crystal display.

The display or other labeling may also show other information including the name 66 address, and phone number, account number and address of the person for whom the medicines are intended; a prescribing physician's name 68, phone number and address (if the medicines are provided under a prescription); a prescription number (if the medicines are provided under a prescription) 70; number of refills remaining on a prescription (if the medicines are provided under a prescription) 72; the name 74, address 76 and phone number 78 of a pharmacy or other retail establishment; a bar code 80; the name and dose of the medicines 82; instructions regarding taking the medicines or restrictions regarding taking the medicines 84. The information listed on any of the labels may be varied, or additional information added, such as, for example, one or more of the date of issue of the prescription, expiration date of the medication, total number of pills or other medications dispensed, physician state license number, physician Drug Enforcement Administration license number, or pharmacy license number, dependent upon the desires of the patient, pharmacy, or health care provider, and/or to comply with federal, state, or local laws or regulations regarding pharmacy labeling.

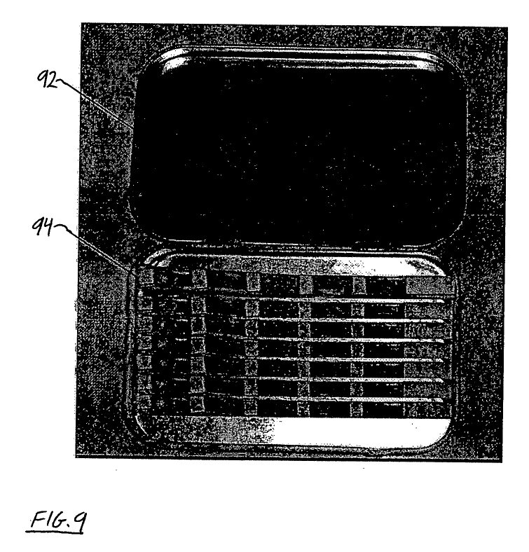

As shown in FIG. 8, this embodiment includes a label on the other side of the aforementioned dispenser that includes the name 86 and dose 88 of each medicine, as well as a barcode for each 90. The label may be configured to correspond to the position of the individual medication and label.

This labeling may also include the address and phone number of the person for whom the medicines are intended or of a prescribing physician; the phone number of a pharmacy or other retail establishment; or restrictions regarding taking the medicines.

The invention may also include a mechanism for manually removing medicines in the absence of a button or other dispensing mechanism, or if such a mechanism is inoperable. In this embodiment shown in FIG. 9, the dispenser has a lid 92 that can be opened to remove some or all of the medicines, or all or some of the strips 94.

The invention may also include electronics that record information regarding when the medicines have been dispensed, including day, time and date. The invention also may include a data port that allows the dispenser to be hooked up to a computer, personal digital assistant, cellular or landline telephone, other electronic device, or directly to the internet to download, view or transmit such data, such as to the patient's health care provider or to the pharmacy to request a refill. Data may also be transmitted in a wireless format, such as wi-fi, Bluetooth, infrared, or radio transmission, or digitally stored in memory on the invention itself, such as on a flash memory device, hard drive, or floppy.

The invention may also include electronics that allow the dispenser to be programmed with information regarding when the medicines should be dispensed and taken. The invention may further include a means of notifying the person for whom the medicines are intended, or a caregiver or other person, when it is time to dispense and take the medicines. Such a means of notification may include one or more of a light, an electronic display, an alarm, or a vibrating mechanism.

Another embodiment is a box containing four weekly dispensers. This is done to provide a format consistent with common prescription writing habits which are typically for 30, 60, or 90 days.

Any of a wide variety of specific combinations of medications may be utilized in combination with the multi-compartment strips and dispensers of the present invention. For example, based on guidelines from the American College of Cardiology, patients diagnosed with a myocardial infarction, and patients diagnosed with unstable angina receive, if indicated, the following five therapies after leaving the hospital: an aspirin, a thienopyridine, such as clopidigrel or ticlopidine; a beta-blocker, such as acebutolol, atenolol, betaxolol, bisoprolol, carvedilol, labetalol, metoprolol, nadolol, or propranolol; an angiotensin-converting enzyme-I inhibitor (ACE inhibitor), such as benazepril, captopril, cilazapril, enalapril, fosinopril, lisinopril, moexipril, perindopril, quinapril, ramipril, or trandolapril; and a HMG CoA reductase inhibitor (also commonly known as a statin), such as lovastatin, simvastatin, pravastatin, fluvastatin, atorvastatin, or rosuvastatin. Of note, aspirin, dipyridamole, and thienopyridines are examples of anti-platelet agents. Anti-platelet agents also are under the broader classification of anti-thrombotic agents. Patients intolerant to ACE inhibitors because of cough, angioedema, or other reason may be on an angiotensin-II receptor blocker (ARB) instead, such as candesartan, irbesartan, olmesartan, losartan, valsartan, telmisartan, or eprosartan. Patients may be prescribed a bile-acid binding resin (such as cholestyramine), gemfibrozil, and/or niacin in addition to a statin, or as a substitute if they are intolerant to a statin.

As another example, congestive heart failure patients are typically on combinations of drugs which may include an aspirin, an ACE inhibitor, a beta-blocker, a diuretic (including loop diuretics such as bumetanide, ethacrynic acid, furosemide, or torsemide; thiazide diuretics including chlorothiazide, chlorthalidone, hydrochlorothiazide, indapamide, methyclothiazide, metolazone, polythiazide; and other diuretics such as acetazolamide, amiloride, spironolactone, and triamterene), and a positive inotropic agent such as digoxin. Patients with congestive heart failure and additionally, impaired renal function may be prescribed a combination of hydralazine and a nitrate instead of an ACE inhibitor. Those patients with an arrhythmia history may additionally be on anti-arrhythmic agent such as amiodarone, disopyramide, flecainide, mexiletine, propafenone, sotalol, or quinidine. Those patients with an increased risk or history of embolic stroke may be also placed on an anti-thrombotic agent, such as warfarin, aspirin, dipyridamole, or a thienopyridine. These regimens may also include oral forms of anti-thrombotics that may become available including direct thrombin inhibitors, oral heparins, and oral glycoprotein 2b3a inhibitors.

As yet another example, patients who receive organ transplants are often prescribed a number of immunosuppressant medicines. Transplant patients begin therapy before, during, or soon after transplantation surgery to guard against rejection by the host immune system. These patients are required to take immunosuppressive therapies, usually for the rest of their lives. Drugs used to prevent organ rejection include cyclosporine, prednisone, azathioprine, 6-mercaptopurine (6-MP), tacrolimus (FK-506), mycophenolate mofetil, sirolimus, OKT3, ATGAM, and thymoglobulin.

A further embodiment, tailored for a patient post-myocardial infarction or with unstable angina, involves combining an individual dose of two or more of the following medications in a system: a statin, a beta-blocker, an ACE inhibitor, a thienopyridine, and an aspirin. These regimens may also include oral forms of anti-thrombotics that may become available including direct thrombin inhibitors, oral heparins, and oral glycoprotein 2b3a inhibitors.

A further embodiment, tailored for a patient with congestive heart failure, involves combining an individual dose of two or more of the following medications in a system: a beta-blocker, one or more diuretics, an ACE inhibitor, digoxin, hydralazine, a nitrate, warfarin, and an anti-arrhythmic. These regimens may also include oral forms of anti-thrombotics that may become available including direct thrombin inhibitors, oral heparins, and oral glycoprotein 2b3a inhibitors.

A further embodiment, tailored for a patient with an arrhythmia, such as atrial fibrillation or atrial flutter, involves combining an individual dose of two or more of the following medications in a system: aspirin, warfarin, an anti-arrhythmic, and one or more rate-control agents such as a beta-blocker, a non-dihydropyridine calcium-channel blocker (such as diltiazem or verapamil), and digoxin.

A further embodiment, tailored for a patient who has undergone organ transplantation, involves combining an individual dose of two or more of the following medications in a system: cyclosporine, prednisone, azathioprine, 6-mercaptopurine (6-MP), tacrolimus (FK-506), mycophenolate mofetil, sirolimus, OKT3, ATGAM, and thymoglobulin.

A further embodiment, tailored for a patient who has diabetes mellitus, involves combining an individual dose of two or more of the following medications in a system: a sulfonylurea (such as glipizide, glyburide, chlorpropramide, or glimeprimide); a biguanide (such as metformin); a thiazolidinedione (such as pioglitazone or rosiglitazone), a meglitinide (such as repaglinide or nateglinide) and an alpha-glucosidase inhibitor (such as acarbose or miglitol). Sulfonylureas, biguanides, thiazolidinediones, meglitidines, alpha-glucosidase inhibitors, and the like may be all generally referred to as oral hypoglycemic agents.

A further embodiment, tailored for a patient who has hypertension, involves combining an individual dose of two or more of the following medications in a system: a beta-blocker, a diuretic, a calcium-channel blocker (such as diltiazem, verapamil, nifedipine, amlodipine, nicardipine, isradipine, nimodipine, or nisoldipine), an ACE inhibitor, an ARB, hydralazine, a nitrate, an alpha-blocker (such as clonidine), a direct vasodilator (such as hydralazine, minoxidil), and methyldopa.

A further embodiment, tailored for a patient who has tuberculosis, involves combining an individual dose of two or more of the following medications in a system: isoniazid, rifampin (or rifabutin or rifampicin), pyrazinamide, ethambutol, streptomycin, and another anti-tubercular agent.

A further embodiment, tailored for a patient who has HIV or AIDS, involves combining an individual dose of two or more of the following medications in a system: a protease inhibitor (such as tipranavir, indinavir, saquinavir, lopinavir+ritonavir combination, fosamprenavir, ritonavir, atazanavir, or nelfinavir), a nucleoside/nucleotide reverse transcriptase inhibitor (NRT) (such as AZT+3TC combination, emtriciabine, 3TC, abavacir+3TC combination, AZT, AZT+3TC+abacavir combination, emtricitabine+tenofovir combination, ddI, tenofovir, d4T, or abacavir), a non-nucleoside reverse transcriptase inhibitor (NNRT) (such as delaviridine, efavirenz, or nevirapine), an entry inhibitor (such as T-20), a Pneumocystis carinii prophylaxis agent (such as trimethoprim-sulfamethoxazole, dapsone, atovaquone, clindamycin, or primaquine), and a Mycobacterium avium-complex prophylaxis agent (such as azithromycin). One skilled in the art will recognize that a system for a patient with HIV or AIDS may include more than one medication from each class, such as three NRTs.

A further embodiment, tailored for a patient who has Parkinson's disease, involves combining an individual dose of two or more of the following medications in a system: carbidopa-levodopa combination, biperiden, apomorphine, trihexyphenidyl, diphenhydramine, benztropine, bromocriptine, entacapone, selegiline, hyoscyamine, pramipexole, pergolide, ropinirole, amantadine, tolcapone, and any other anti-Parkinsonian agent.

A further embodiment may include multiple medications for a patient with more than one medical problem. For example, in one such preferred embodiment, tailored for a patient who is status-post myocardial infarction or has unstable angina, and additionally has diabetes mellitus, involves combining an individual dose of two or more of the following medications in a system: a sulfonylurea (such as glipizide, glyburide, chlorpropramide, or glimeprimide), a biguanide (such as metformin), a thiazolidinedione (such as pioglitazone or rosiglitazone), a meglitinide (such as repaglinide or nateglinide), an alpha-glucosidase inhibitor (such as acarbose or miglitol); a statin, a beta-blocker, an ACE inhibitor, a thienopyridine, and an aspirin.

A further embodiment involves combining individual doses of two or more medications in a system based on practice guidelines from medical associations and other recognized authorities in the medical field.

A further embodiment involves combining individual doses of two or more medications in a system based on the unique, specific medical problems of a particular patient and the sound judgment of a licensed physician or other health care professional. A skilled artisan will also note that a there are a myriad of possible individualized combinations of medications based on the requirements of the physician and patient, and that new medications may be introduced in the future for any medical condition and may be substituted into the system. Similarly, a medication listed may in the future no longer be indicated for a particular medical problem.

The present invention has been described in terms of certain preferred embodiments for the purpose of illustration and discussion. However, the foregoing discussion is not intended to limit the scope of the present invention. Instead, the scope of the invention is to be limited solely by the attached claims.

What is claimed is:

1. A multicompartment drug dispensing device, comprising:
at least a first compartment and a second compartment;
at least a first pill in the first compartment, and a second pill in the second compartment;
a first label on the first compartment, containing information about the first pill; and
a second label on the second compartment, containing information about the second pill.

2. A multicompartment drug dispensing device as in claim 1, wherein the information on the first label includes at least, for each pill, the drug name and serial number, the patient name, and the prescriber's name,

3. A multicompartment drug dispensing device as in claim 2, comprising at least three compartments.

4. A multicompartment drug dispensing device as in claim 3, wherein the compartments are detachably connected to each other.

5. A multicompartment drug dispensing device as in claim 3, wherein each compartment may be opened separately from the other compartments.

6. A multicompartment drug dispensing device as in claim 2, wherein at least one compartment contains a pill that comprises a prescription medication.

7. A multicompartment drug dispensing device as in claim 2, wherein at least one compartment contains a pill that comprises a statin.

8. A multicompartment drug dispensing device as in claim 7, wherein at least one compartment contains a pill that comprises a non prescription medication.

9. A multicompartment drug dispensing device as in claim 8, wherein the non prescription medication comprises aspirin.

10. A multicompartment drug dispensing device as in claim 7, wherein at least one compartment contains a pill that comprises an ACE inhibitor.

11. A multicompartment drug dispensing device as in claim 2, wherein at least one compartment contains a pill that comprises an anti-thrombotic agent.

12. A multicompartment drug dispensing device as in claim 2, wherein at least one compartment contains a pill that comprises an anti-platelet agent.

13. A multicompartment drug dispensing device as in claim 2, wherein at least one compartment contains a pill that comprises a thienopyridine.

14. A multicompartment drug dispensing device as in claim 2, wherein at least one compartment contains a pill that comprises an ARB.

15. A multicompartment drug dispensing device as in claim 2, wherein at least one compartment contains a pill that comprises a cholesterol lowering agent.

16. A multicompartment drug dispensing device as in claim 2, wherein at least one compartment contains a pill that comprises an oral hypoglycemic agent.

17. A multicompartment drug dispensing device as in claim 7, additionally comprising an ACE inhibitor pill, an aspirin pill, a thienopyridine pill, and a beta blocker pill

18. A plurality of multicompartment drug dispensing devices as in claim 1, associated together as a single article.

19. A multicompartment drug dispensing device as in claim 1, wherein at least the first compartment comprises a peel away cover.

20. A multicompartment drug dispensing device as in claim 1, wherein at least the first compartment comprises a perforation line.

21. A multicompartment drug dispensing device as in claim 1, wherein at least the first compartment comprises a frangible barrier.

22. A multicompartment drug dispensing device as in claim 21, wherein the frangible barrier comprises a metal foil.

23. A multicompartment drug dispensing device as in claim 1, wherein at least the first compartment comprises a wall having an ultraviolet light blocking characteristic.

24. A multicompartment container, comprising:
a housing, defining a plurality of wells;
a removable cover, for covering the plurality of wells to define a plurality of enclosed compartments;
a dose of medication in each compartment; and
a label on each compartment which includes an identification of the medication contained in that compartment, the identification comprising at least the dose of the medication, a patient's name, and a prescription number.

25. A multiple drug dispensing system, comprising:
a first housing;
a plurality of multicompartment containers in the first housing; each multi-compartment container comprising:
a second housing, defining a plurality of wells;
a removable cover, for covering the plurality of wells to define a plurality of enclosed compartments;
a dose of medication in each compartment; and
a label on each compartment which includes an identification of the medication contained in that compartment, the dose of the medication, a patient's name, and a prescription number.

26. A multiple drug dispensing system as in claim 25, further comprising an opening on the first housing, to allow removal of the multicompartment containers.

27. A method of packaging a multiple drug therapy, comprising the steps of:
providing a multicompartment container;
placing a first dose of a first drug in a first compartment;
placing a second dose of a second, different drug in a second compartment;
labeling the first compartment with information relating to the first drug; and
labeling the second compartment with information relating to the second drug.

28. A method of packaging a multiple drug therapy as in claim 27, additionally comprising the step of applying a removable cover to enclose each compartment.

29. A method of packaging a multiple drug therapy as in claim 28, additionally comprising the step of associating a plurality of multicompartment containers into a single unit.

30. A method of packaging a multiple drug therapy as in claim 29, wherein the associating step comprises wrapping the multicompartment containers together in an outer wrapping.

31. A method of packaging a multiple drug therapy as in claim 29, wherein the associating step comprises placing the multicompartment containers in an outer container.

32. A method of packaging a multiple drug therapy as in claim 29, wherein the associating step comprises releasably securing the multicompartment containers to each other.

33. A method of treating a patient, comprising the steps of:
providing a plurality of multicompartment housings, each housing containing a dose of each of at least three different drugs to be taken by the patient, each dose contained within a unique compartment within the housing and the housing having a unique label for each dose;
providing an instruction to the patient to select one of the plurality of housings at a predetermined time interval, and open the housing to release the dose of each of the said at least three different drugs.

34. A method of treating a patient post-myocardial infarction, comprising the steps of:
providing a plurality of multicompartment housings, each housing containing a dose of at least three different drugs to be taken by the patient; where said drugs are a statin, a beta-blocker, and an ACE inhibitor, each dose contained within a unique compartment within the housing and the housing having a unique label for each dose;
providing an instruction to the patient to select one of the plurality of housings at a predetermined time interval, and open the housing to release the dose of each of the said at least three different drugs

35. The method of claim 34, where each housing additionally comprises a dose of an aspirin.

36. The method of claim 34, where each housing additionally comprises a dose of a thienopyridine.

37. The method of claim 34, where each housing additionally comprises a dose of an aspirin and a thienopyridine.

38. A method of treating a patient with congestive heart failure, comprising the steps of:
providing a plurality of multicompartment housings, each housing containing a dose of at least three different drugs to be taken by the patient; where said drugs are a diuretic, a beta-blocker, and an ACE inhibitor, each dose contained within a unique compartment within the housing and the housing having a unique label for each dose;
providing an instruction to the patient to select one of the plurality of housings at a predetermined time interval, and open the housing to release the dose of each of the said at least three different drugs.

39. The method of claim 38, where each housing additionally comprises a dose of a positive inotropic agent.

40. The method of claim 38, where each housing additionally comprises a dose of a statin.

41. The method of claim 38, where each housing additionally comprises a dose of an aspirin.

42. The method of claim 38, where each housing additionally comprises a dose of an aspirin and a statin.

43. The method of claim 38, where each housing additionally comprises a dose of an aspirin and a positive inotropic agent.

44. The method of claim 38, where each housing additionally comprises a dose of a statin and a positive inotropic agent.

45. The method of claim 38, where each housing additionally comprises a dose of a statin, an aspirin, and a positive inotropic agent.

46. A method of treating a patient with diabetes mellitus, comprising the steps of:
providing a plurality of multicompartment housings, each housing containing a dose of at least three different drugs to be taken by the patient; where said drugs are a sulfonylurea, a biguanide, and an ACE inhibitor, each dose contained within a unique compartment within the housing and the housing having a unique label for each dose;
providing an instruction to the patient to select one of the plurality of housings at a predetermined time interval, and open the housing to release the dose of each of the said at least three different drugs.

47. The method of claim 46, where said drugs are a sulfonylurea, a thiazolidinedione, and a biguanide.

48. The method of claim 46, where said drugs are a sulfonylurea, a thiazolidinedione, and an ACE inhibitor.

49. The method of claim 46, where said drugs are a thiazolidinedione, a biguanide, and an ACE inhibitor.

50. A multicompartment drug dispensing device for a patient post-myocardial infarction or with unstable angina, comprising:
at least a first compartment, a second compartment, and a third compartment;
at least a first pill in the first compartment, a second pill in the second compartment; and a third pill in the third compartment;
a first label on the first compartment, containing information about the first pill;
a second label on the second compartment, containing information about the second pill;
and a third label on the third compartment, containing information about the third pill;
wherein information on the first label includes, at least, for each pill, the drug name and serial number, the patient name, and the prescriber's name;
wherein the pills comprise a statin, an ACE inhibitor, and a beta-blocker.

51. The multicompartment drug dispensing device of claim 50, additionally comprising a thienopyridine pill.

52. The multicompartment drug dispensing device of claim 50, additionally comprising an aspirin pill.

53. The multicompartment drug dispensing device of claim 50, additionally comprising an aspirin pill and a thienopyridine pill.

54. A multicompartment drug dispensing device for a patient with congestive heart failure, comprising:
at least a first compartment, a second compartment, and a third compartment;
at least a first pill in the first compartment, a second pill in the second compartment; and a third pill in the third compartment;
a first label on the first compartment, containing information about the first pill;
a second label on the second compartment, containing information about the second pill;
and a third label on the third compartment, containing information about the third pill;
wherein information on the first label includes, at least, for each pill, the drug name and serial number, the patient name, and the prescriber's name; wherein the pills comprise a diuretic, an ACE inhibitor, and a beta-blocker.

55. The multicompartment drug dispensing device of claim 54, additionally comprising an aspirin pill.

56. The multicompartment drug dispensing device of claim 54, additionally comprising a positive inotropic agent pill.

57. The multicompartment drug dispensing device of claim 54, additionally comprising a second diuretic pill; said diuretic pill being spironolactone.

58. The multicompartment drug dispensing device of claim 54, additionally comprising a positive inotropic agent pill and a second diuretic pill; said diuretic pill being spironolactone.

59. The multicompartment drug dispensing device of claim 54, additionally comprising a positive inotropic agent pill, an aspirin pill, and a second diuretic pill; said diuretic pill being spironolactone.

60. A multicompartment drug dispensing device for a patient with diabetes, comprising:
at least a first compartment, a second compartment, and a third compartment;
at least a first pill in the first compartment, a second pill in the second compartment; and a third pill in the third compartment;
a first label on the first compartment, containing information about the first pill;
a second label on the second compartment, containing information about the second pill;
and a third label on the third compartment, containing information about the third pill;
wherein information on the first label includes, at least, for each pill, the drug name and serial number, the patient name, and the prescriber's name;
wherein the pills comprise two different oral hypoglycemic agents and an ACE inhibitor.

61. The multicompartment drug dispensing device of claim 59, additionally comprising a statin pill.

62. The multicompartment drug dispensing device of claim 59, wherein the pills comprise three different oral hypoglycemic agents.
